(19) United States
(12) Patent Application Publication
(10) Pub. No.: US 2003/0014631 A1
(43) Pub. Date: Jan. 16, 2003

(54) Method and system for user and group authentication with pseudo-anonymity over a public network

(76) Inventor: Steven Sprague, Lenox, MA (US)

Correspondence Address: BAKER & BOTTS, 30 ROCKEFELLER PLAZA, NEW YORK, NY, 10112

(21) Appl. No.: 09/906,375

(22) Filed: Jul. 16, 2001

(51) Int. Cl. H04L 9/00

(52) U.S. Cl. 713/168

(57) ABSTRACT

A method of authorizing anonymous access to content by an individual user or a member of an authorized group of users is provided. The method includes receiving a request for access from a user having a persona identifier. Next, a challenge message is generated that includes, at least in part, the persona identifier and verification data, such as pseudo random data. The challenge message is provided to a persona server, which operates as an authentication agent that generates an authentication object extractable only by an individual user or group member. Upon receiving an authentication object from the persona server. The user retrieves decryption data from the persona server. The authentication object is forwarded to the user. If the persona user is authentic, the authentication object packaging is stripped by secure hardware at the user computer using the data from the persona server and the verification data is extracted. Upon receiving and confirming the verification data from the user, the content provider grants the user access to the selected content.

### FIELD OF THE INVENTION

The present invention relates generally to the access and use of content over a public network, such as the Internet, and more particularly relates to a system for access and use of content over a public network where users and groups are identified by a persona which is verifiable by a combination of the operations of the user computer and an authentication server.

### BACKGROUND OF THE INVENTION

The Internet is a vast public network that is now used by millions of users to access content and to engage in electronic commerce transactions. The growth of the Internet, however, has lead to concerns regarding the security of transactions over a public network and the unauthorized use of personal information and personal profiles for improper purposes. For example, as a user accesses a website on the Internet, the user may be required to register with the service provider and divulge personal information and payment information, such as credit card data. The user's activities can be tracked and this information used to establish personal profiles which are commonly sold to others interested in directing marketing efforts to users with certain profiles. Such marketing efforts generally result in unsolicited and unwanted advertisements being directed to the consumer. There is also concern that such profiles can be used for improper purposes, such as theft of an individual's identity and other crimes against the user.

U.S. Pat. No. 5,815,665, the entire specification of which is herein incorporated by reference, is directed to a system and method for providing trusted brokering services over a distributed network. In the systems and methods disclosed in this patent, a user requests access to a content provider and is provided with a “challenge” message. The user computer provides a response to the challenge message which is passed by the service provider to an online broker server. The broker server uses the response to verify the user identity and provide an anonymous identifier for the user to the content provider for subsequent billing purposes. In this system, the “trust” resides with the broker server and not with the client.

It would be desirable to have a system where the identity of the user remains anonymous and the user was verifiable by a trusted client computer or the combination of a trusted server and a trusted client computer.

### OBJECTS AND SUMMARY OF THE INVENTION

It is an object to provide a system and method for enabling electronic commerce transactions over a public network while maintaining a substantial degree of user anonymity.

It is a further object to provide a system and method for enabling an individual user or a group of users to be identified by a persona or alias which can be authorized by an authentication server and a user of a trusted client computer.

It is yet another object to authenticate that a user is a member of an authorized group of users without the individual user's identity being disclosed.

A method for one or more user(s) to access content anonymously from a third party content provider computer includes the step of a user registering a persona having a persona identifier with a persona server to generate an access record. In the case of a group of users, once an access record for the group is generated, additional personas can be added to the access record by modifying the existing access record. A user requests access to content from the content provider using the persona identifier. In response, the content provider computer generates a challenge message including, at least in part, the persona identifier and data uniquely verifiable by the content provider computer, and submits the challenge message to the persona server. The persona server associates the persona identifier of the challenge message with the access record and generates an authentication object including the data uniquely verifiable by the content provider computer enveloped in such a manner that it is extractable only by a computer of a user of the persona authorized to retrieve the access record. The user receives the authentication object and retrieves the access record from the personal server. Using data stored in the access record, the user extracts the data which is uniquely verifiable by the content provider computer. The user then submits the extracted data which is uniquely verifiable by the content provider computer to the content provider for authentication and access control.

Another embodiment of the present invention is a method for authorizing anonymous access to content that includes: receiving a request for access from a user having a persona identifier; generating a challenge message including, at least in part, the persona identifier and verification data; submitting the challenge message to the persona server; receiving an authentication object from the persona server and forwarding the authentication object to the user computer, the authentication object packaging the verification data such that it is accessible only by the authorized user computer; receiving the verification data from the user computer; and granting access to the user if the verification data is correct.

The present invention also includes a method of generating an authentication object for a user of a persona to access content anonymously, which is generally performed by a persona server acting as an authorization agent. The method includes registering a user persona by creating an access record based at least in part on a persona identifier and registration data provided by a user associated with the persona identifier. Upon receiving a challenge message from a content provider computer, including the persona identifier and verification data, the method provides for enveloping at least the verification data in accordance with data stored in the access record associated with the persona identifier to generate an authentication object. The authentication object is provided either to the content provider computer, which in turn forwards it to the persona user, or directly to the persona user. If the persona user requesting access to the content provider is authentic, the user computer can retrieve the access record, extract the verification data and submit the verification data to the content provider for authentication.

Also in accordance with the present invention is a system for authenticating a user of a persona prior to granting access rights over a public network. The system includes a plurality of client computers which are operatively coupled to the public network. The client computers store at least one persona identifier. Preferably, the persona identifiers are stored in secure hardware which is operatively coupled to the client computer. The system also includes a persona server which is operatively coupled to the public network and maintains a database of access records that are associated with the plurality of persona identifiers. The access records generally include data to associate each persona identifier with the corresponding decryption keys. At least one content provider computer is operatively coupled to the public network. In response to a request for access from one of the plurality of client computers using a persona identifier, the content provider computer generates a challenge message including the persona identifier and verification data associated with the request for access. The content provider computer submits the challenge message to the persona server which in turn generates an authentication object.

The authentication object generally includes the verification data encrypted based on data in the access record associated with the persona identifier. The authentication object is then presented to the client computer requesting access. If the client computer is an authentic user of the persona, the client computer can retrieve data from the access record to decrypt the authentication object and return the verification data to the content provider computer to establish user authentication.

Also in accordance with the present invention is a system for authenticating a member of a group of users of a persona prior to granting access rights over a public network. The system includes a plurality of client computers which are operatively coupled to the public network. The client computers store at least one group identifier. Preferably, the group identifiers are stored in secure hardware which is operatively coupled to the client computer. The system also includes a persona server which is operatively coupled to the public network and maintains a database of access records that are associated with the plurality of group identifiers. The access records generally include data to associate each group identifier with the corresponding decryption keys. At least one content provider computer is operatively coupled to the public network. In response to a request for access from one of the plurality of client computers using a group identifier, the content provider computer generates a challenge message including the group identifier and verification data associated with the request for access. The content provider computer submits the challenge message to the persona server which in turn generates an authentication object.

The authentication object generally includes the verification data encrypted based on data in the access record associated with the group identifier. The authentication object is then presented to the client computer requesting access. If the client computer is an authentic member of the group, the client computer can retrieve data from the access record to decrypt the authentication object and return the verification data to the content provider computer to establish user authentication.

These and other objects and features of the invention will become apparent from the description of preferred embodiments of the present invention in connection with the drawings.

### BRIEF DESCRIPTION OF THE DRAWINGS

The invention will be described in connection with certain preferred embodiments thereof in connection with the following drawings, in which:

FIG. 1 is a simplified block diagram illustrating the present system;

FIG. 2 is a simplified block diagram of the present system and further illustrating the functional blocks of one embodiment of the persona server;

FIG. 3 is a flow chart illustrating the process of accessing a third party content provider server with a user persona, in accordance with the present invention;

FIG. 4 is a flow chart which further illustrates the process of a user generating an authentication object in accordance with one embodiment of the invention; and

FIG. 5 is a flow chart illustrating the process of registering a persona with a third party content provider website.

FIG. 6 is a system level flow diagram illustrating an embodiment of a persona registration process.

FIG. 7 is a system level flow diagram illustrating an embodiment of use of a persona to gain access to a third party content provider.

### DETAILED DESCRIPTION OF PREFERRED EMBODIMENTS

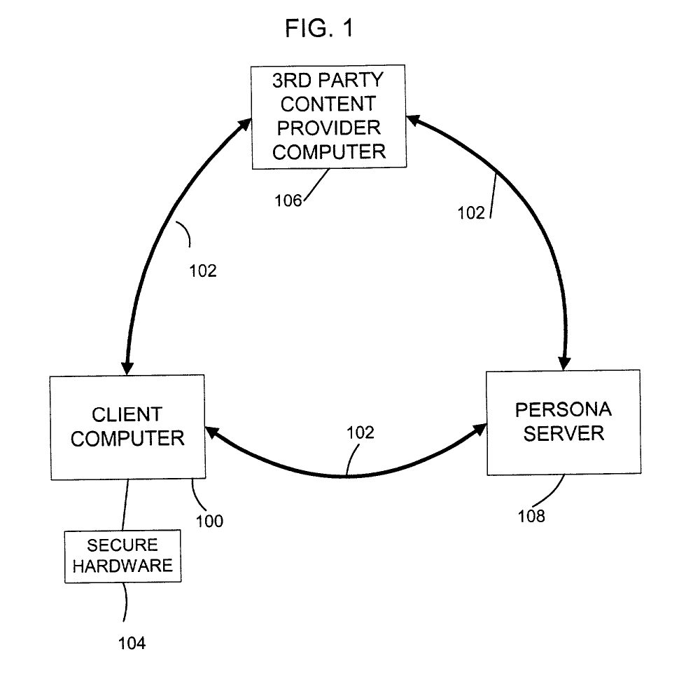

FIG. 1 is a simplified block diagram of the present system for authenticating individual users or individual members of a group of users using a pseudo-anonymous identifier, which is referred to herein as a persona. The persona is an identifier which is used to grant rights to users and enable transactions between users and third parties while protecting the actual identity of the user. A user or group of users can have a number of personas which are used for different service providers or content providers. In this way, the ability of such providers to share and accumulate user profile data is reduced.

Referring to FIG. 1, a client computer 100 is operated by a user and includes appropriate interface circuitry to access a public network 102, such as the Internet. The client computer 100 can take the form of a personal computer, set-top box, hand held computing device and the like.

To insure a level of security or trust in the client computer 100, the client computer 100 includes secure hardware 104 to facilitate the payment for goods and services purchased over the public network 102. The secure hardware 104 preferably includes a dedicated microprocessor and a secure memory area for storing encryption keys and the like. The secure hardware 104 can take the form of a SURF (secure usage reporting functions) device and associated software, such as the USB WaveMeter™ which includes a SURF C device and is available from Wave Systems Corporation of Plainsboro, N.J. The SURF protocol is described in U.S. Pat. Nos. 5,351,293, 5,615,264, 5,671,283 and 5,764,762 which are hereby incorporated by reference in their entireties. The SURF hardware can be embedded in the client computer or can be added as a peripheral device connected to an interface port of the client computer 100. The use of appropriate secure hardware 104 and software can render the client computer 100 into a trusted client, i.e., there is a high level of assurance that once verified, the identity of the client is authentic rather than being an imposter or “hacker.”

An overview of the operation of the system of FIG. 1 is now provided. The client computer 100 communicates with a content provider computer 106 via the public network 102. Similarly, the client computer 102 communicates with a persona server 108 via the public network 102. In addition, communication between the content provider computer 106 and the persona server 108 is also provided via the public network 102. In general, a user of the client computer 102 will request access to the content provider computer 106 and will identify itself with a persona identifier. The content provider computer 106 will provide the persona identifier, along with a challenge message, to the persona server 108. The persona server will generate an authentication object based upon the information provided by the third party content provider computer and data stored in a database having an access record associated with the persona. The authentication object is provided to the content provider computer 106 which in turn passes the authentication object to the client computer 100. Using the secure hardware 104 and data from the persona server 108, the client computer 100 extracts the challenge data and provides the challenge data to the content provider computer 106 as user authentication.

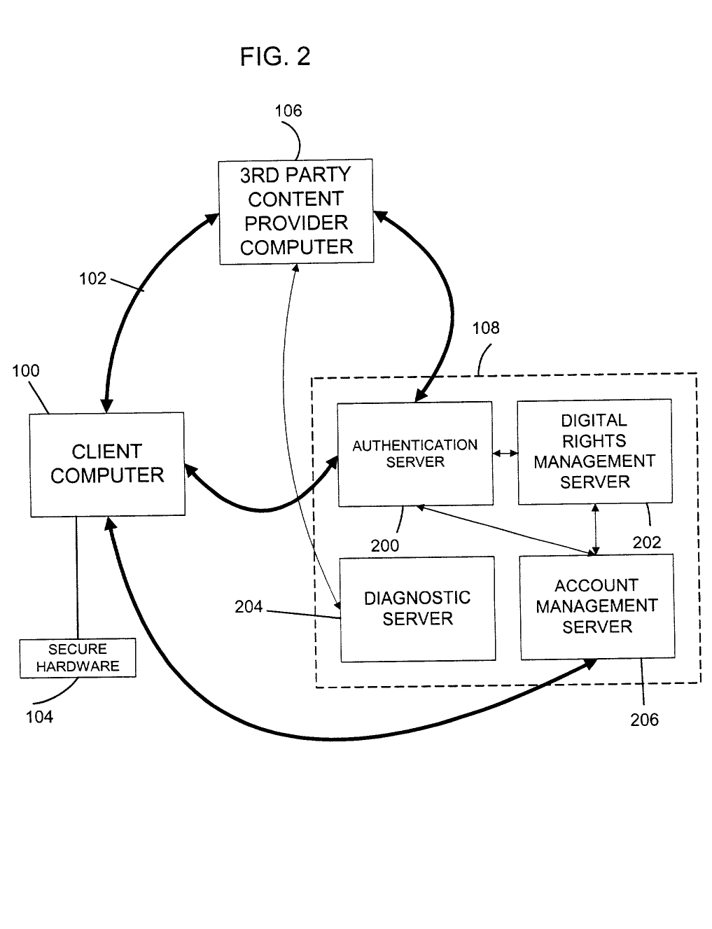

FIG. 2 is a block diagram of the system of FIG. 1 that further illustrates an exemplary embodiment of the persona server 108. In this embodiment, the persona server 108 includes an authentication server 200 which is operatively coupled to the client computer 100 and the content provider computer 106 via the public network 102. There is also a digital rights management (DRM) server 202 and an account management server 206 which are in electrical communication with each other and with the authentication server 200. The DRM server 202 can take the form of a MyPublish server provided by Wave Systems Corporation of Plainsboro, N.J., which is a known computer server for enabling the secure publication of digital content on a public network, such as the Internet.

The account management server 206 can take the form of a WaveNet server provided by Wave Systems Corporation of Plainsboro, N.J., which is a known computer server for enabling secure payment of goods and services over the Internet for client computers having appropriate secure hardware 104 and software, such as SURF based hardware and software. A diagnostic server 204 can also be provided. The Envoy Diagnostic Web Server from Wave Systems Corporation of Plainsboro, N.J., is suitable for this application.

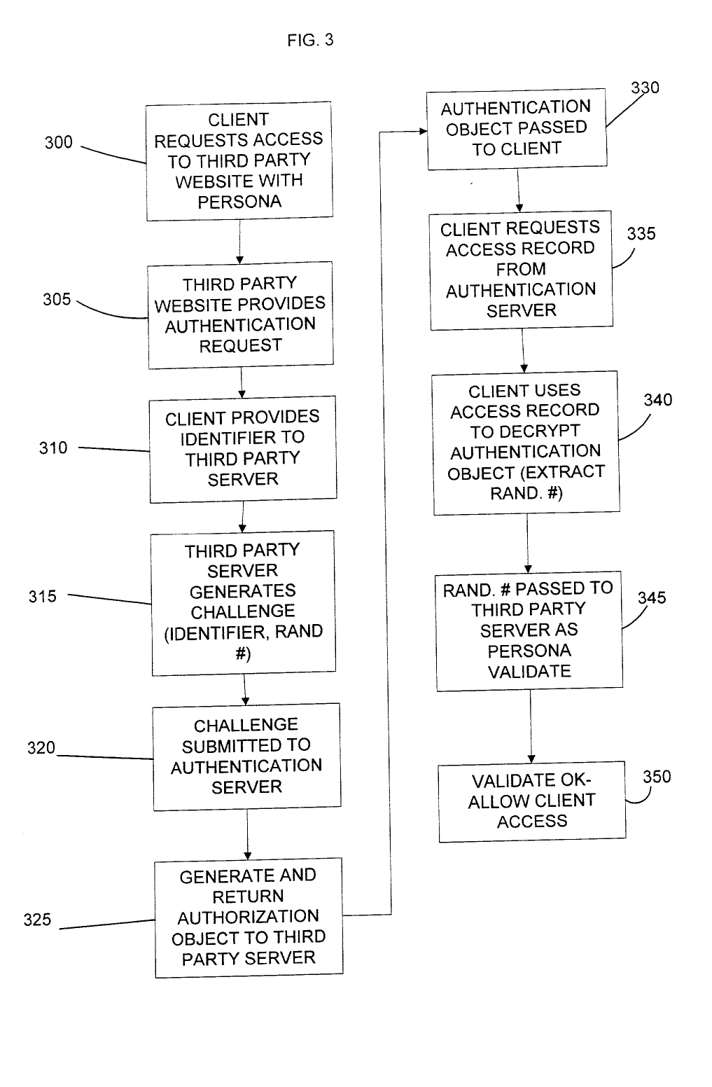

FIG. 3 is a flow chart illustrating the operation of the present system in the case where a user has previously registered a persona with the content provide computer 106 and persona server 108. A request for access to content available on the content provider computer 106 is provided by the client computer 100 using a registered persona (step 300). The content provider computer 106 responds to this request for access by providing an authentication request message to the client computer (step 305). The client computer 106 responds by providing a persona identifier associated with the persona to the third party content server 100 (step 310). The third party content server 106 generates a challenge message which includes data to identify the persona and data which is uniquely identifiable by the content provider computer 106. In one embodiment, the challenge message can take the form of the persona identifier along with a random number generated by the third party content server (step 315). The challenge message is then provided to the persona server 108. In the system embodiment of FIG. 2, the authentication server 200 portion of the persona server 108 receives the challenge message from the content provider computer 106 (step 320).

The persona server 108 receives the challenge message from the content provider computer 106 and associates the persona identifier with a record in the access record database that includes one or more additional identification/authentication parameters. From the data provided by the content provider computer 106 and at least a portion of the data which is stored in an associated access record created during persona registration, the persona server 108 generates an authentication object which is passed to the content provider computer 106 (step 325). The content provider computer 106 passes the authentication object to the client computer 100 (step 330). Alternatively, the persona server 108 can pass the authentication object directly to the client computer 100. Upon receipt of the authentication object from the content provider computer 106, the client computer 100 establishes communications with the persona server 108 and accesses the associated access record which is stored in the persona server database (step 335). Using the data from the access record stored in the persona server 108 the client computer decrypts the encrypted envelope of the authentication object to extract the data uniquely verifiable by the content provider computer 106 which was originally generated by the content provider computer 106 for the challenge message (step 340). Preferably, this takes place using the secure hardware 104. The extracted data is then provided to the content provider computer 106 which validates the persona by verifying that the extracted data provided matches the data used to form the challenge message (step 345). Once the persona is validated, the client computer 100 is granted access to the requested content available on the content provider computer 106 (step 350).

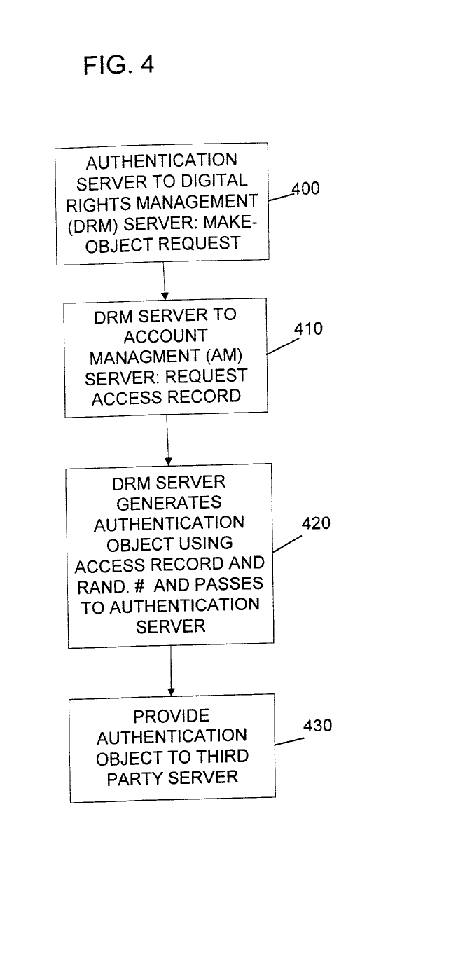

The authentication object which is created by the persona server 108 can take the form of a self merchandising object (SMO) such as that which is used in connection with the MyPublish service, and other services, provided by Wave Systems Corporation of Plainsboro, N.J. A SMO is a datastructure which provides information to a potential consumer of digital information, such as a content description, cost to purchase the information and the like. In the embodiment of FIG. 2, the authentication object is generated by an interaction between the authentication server 200, the digital rights management server 202 and the account management server 206, as illustrated further in the flow chart of FIG. 4.

The authentication server 200 associates the identifier of the persona or group with a publisher identification and a database identification which are pointers to a data set access record stored in one of the digital rights management (DRM) server 202 or account manager server 206. The authentication server 200 generates a make object request, wherein the publisher identifier and database identifier along with the random number of the challenge message are provided to the DRM server 202. If the data set access record associated with the publisher identifier and database identifier is stored on the DRM server 202 the access record is locally recalled. If the data set access record associated with the publisher identifier and database identifier is stored in the account management server 206, the DRM server 202 requests the access record from the account management server (step 410). The data set access record includes persona or group specific encryption keys which are used by the DRM server 202 to encrypt the random number of the challenge message to generate the authentication object which is passed from the DRM server 202 to the authentication server 200 (step 420). The authentication server 200 can correlate the authentication object with the persona or group identifier provided in the challenge message and provide the authentication object to the content provider computer (step 430).

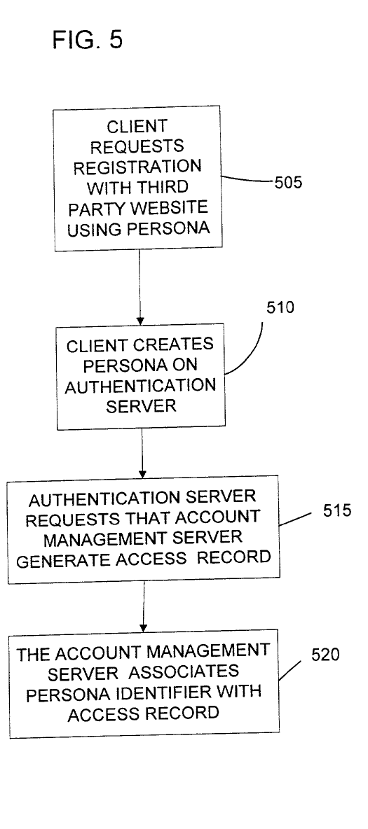

FIG. 5 is a simplified flow chart illustrating a registration process in accordance with the present invention. The process begins when a client, either an individual user or a group representative, desires to access a selected content server 106 using a persona. As is common with current content provider computers, the user operating the client computer 100 enters data on a registration data entry page prior to being granted access to the desired content. However, rather than entering actual identification information, the user enters a persona (step 505). Prior to the registration of the persona with a content server, the user of the client computer generates a persona database entry at the persona server by completing data entry regarding the persona (step 510). The persona will include a persona identifier that is presented to third party computers, such as content provider computer 106.

The authentication server 200 submits a request to the account management server 206 to generate an access record (step 515). The account management server 206 then establishes an association between the created access record and the unique persona identifier (step 520).

The present systems and methods allow users, or members of a group of users, to access content from a content provider computer without revealing actual identification data. The user identity can be mapped to a user persona by a trusted persona server which can generate an authentication object which is consumable only by an authorized user of the persona. Preferably, the user computer consumes, or decrypts, the authentication object using secure hardware attached to the computer, such as secure hardware. In addition to data stored in the secure hardware at the client computer, the client computer can be required to access the persona server to receive additional data required to decrypt the authentication object. Thus, user identity is concealed yet access is granted to the user based on the trust associated with the client computer and the persona server.

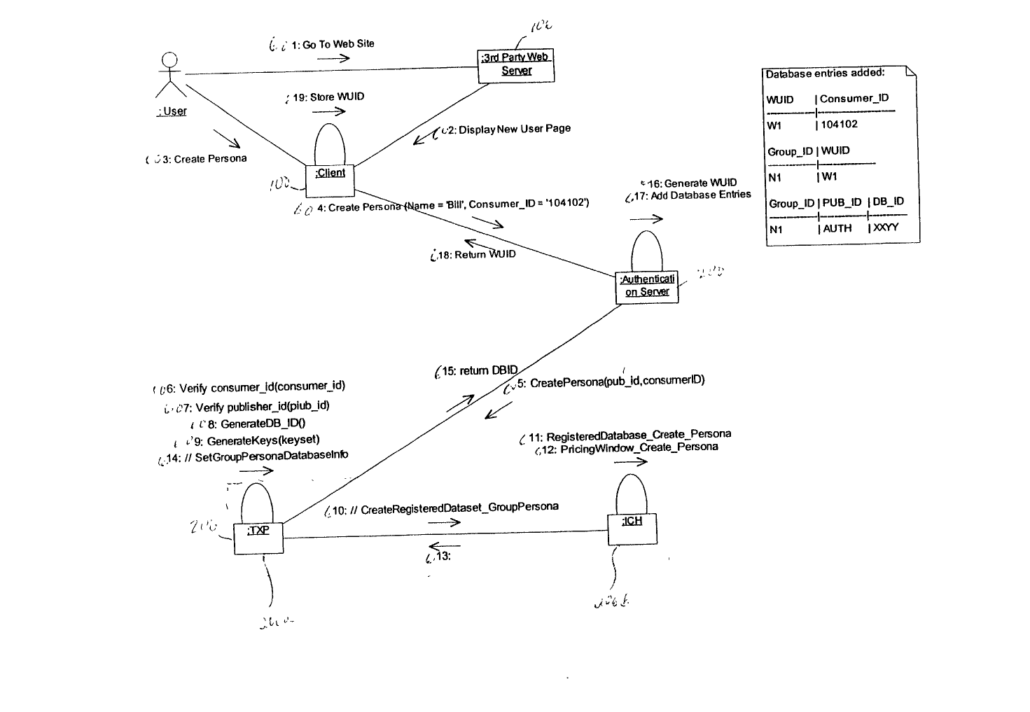

FIG. 6 is a system flow diagram which illustrates a persona registration process in accordance with a particular embodiment of the invention. In this embodiment, the persona server is formed substantially as described in connection with FIG. 2. The account management server 206 is further shown as having a transaction processing section 206a and an information clearing house section 206b. Referring to FIG. 6, a user or group member 600, accesses a website provided by a third party content provider 106 (step 601). The third party content provider computer 106 pushes a new user page to be displayed on the client computer 100 (step 602). The user 600 desiring to access the content provider using a persona, enters a command to create the persona (step 603).

The client computer generates a request to the authentication server 200 to create a persona (step 604). This request can include the persona name (i.e., “Bill”) as well as a consumer identification number (consumer_id) which the authentication server can use to identify the particular individual user or group identification number (group_id) to identify a group of users. The authentication server 200 associates the consumer_id with a publisher identification number (pub_id) and passes a create persona request to the account management server 206 (step 605).

The account management server 206 creates an access record (dataset access record, DAR). Initially, the account management server 206 verifies the consumer_id (step 606) and verifies the publisher_id (step 607). The account management server generates a database identifier (DB_ID) (step 608) and generates one or more encryption keys which will be stored in the access record (step 609).

In step 610, the transaction processing portion 206a of the account management server 206 passes a request to the information clearing house portion 206b to create the entries in the persona database access record for the persona. In step 611 a database entry is created and, if required, a pricing window entry is created (step 612) and control returns to the transaction processing portion (step 613).

If the persona is for a group of users, group information is added to the access record (step 614). When creation of the access record is complete, the database identification data (DB_ID) is passed from the transaction processing portion 206a to the authentication server 200 (step 615). The authentication server 200 generates a user identification (WUID) (step 616) and adds entries to a database (step 617) such that the WUID can be associated with the DB_ID in the account management server 206. The account management server 206 provides the WUID to the client computer (step 618). The client computer stores the WUID (step 619) and provides the WUID to third party content providers when using the persona.

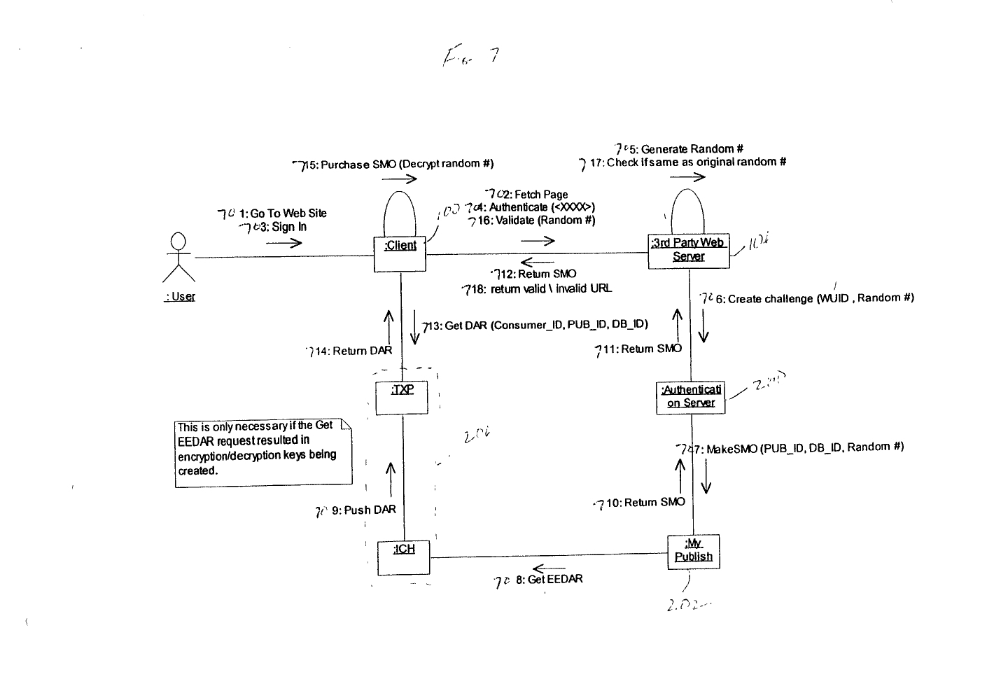

FIG. 7 is a system level flow diagram illustrating the use of a persona which was registered in accordance with the flow diagram of FIG. 6. A user enters a web site address in the client computer (step 601). The client computer fetches a sign-in web page from the third party content provider 106 (step 702). The user provides sign-in information (step 703) and the client computer 100 provides an authentication message, including the WUID generated in FIG. 6, to the third party content provider computer (step 704). The third party content provider computer 106 generates a random number, which is uniquely verifiable by the third party content provider (step 705). The random number, together with the WUID, are provided to the authentication server as a challenge message (step 706).

The authentication server initiates a request to generate an authentication object, such as a self merchandising object (SMO) (step 707). In initiating the request, the authentication server associates the WUID provided by the content provider with the publisher identification (pub_id) and database identification (DB_ID) generated during persona registration.

The digital rights manager server 202 accesses the access record (DAR) from the account manager server 206 (step 708). This request can result in the generation of a session specific encryption key. If so, the key is added to the access record and is pushed to the transaction processing section of the account management server (step 709).

The digital rights manager server 202 generates the authentication object using the encryption keys stored in the access record (step 710). The authentication object is then passed to the third party content provider computer (step 711) and in turn, is passed to the client computer (step 712).

The client computer accesses the account management server 206 to retrieve data from the access record (step 713). The encryption keys in the access record are returned to an authenticated client computer (step 714) which can then open the authentication object (SMO) to decrypt the random number of the challenge message (step 715).

The random number is then provided to the third party content server for validation (step 716). If the random number matches that which was created in the challenge message (step 717) a valid address, such as a URL, is provided to the client computer to authorize access to the desired content (step 718).

In the event a session specific key is created in step 708, the random number of the challenge message is encrypted by the session specific key and the session specific key is then encrypted with the keys created during persona registration. The encrypted session specific key and challenge message together form the authentication object.

When the client computer retrieves the access record, the keys created during registration are used to decrypt the session specific key and the decrypted session specific key is then used to decrypt the random number of the challenge message. This generally takes place using the secure hardware 104 of the client computer 100.

The present invention has been described in connection with certain preferred embodiments thereof. It will be appreciated that certain changes and modifications can be implemented by those skilled in the art with respect to such embodiments and that such modifications are within the scope and spirit of the invention as set forth in the appended claims.

What is claimed is:

1. A method for a user of a computer to access content anonymously from a third party content provider computer comprising:
registering a persona having a persona identifier with a persona server to generate an access record;
requesting access to content from the content provider using the persona identifier;
the content provider generating a challenge message including, at least in part, the persona identifier and data uniquely verifiable by the content provider, and submitting the challenge message to the persona server;
the persona server associating the persona identifier with the access record and generating an authentication object including the data uniquely verifiable by the content provider enveloped in a manner extractable only by an authorized user of the persona;
the user computer receiving the authentication object;
the user computer retrieving data from the access record;
the user computer extracting the data uniquely verifiable by the content provider using the data from the access record; and
the user computer submitting the extracted data to the content provider for authentication.

2. The method for a user of a computer to access content anonymously according to claim 1, wherein the user is a member of a group of authorized users and the persona identifier is associated with the group.

3. The method for a user of a computer to access content anonymously according to claim 1, wherein the data uniquely verifiable by the content provider is pseudo-random data generated by the content provider computer.

4. The method for a user of a computer to access content anonymously according to claim 1, wherein the user can register a plurality of persona identifiers with the persona server.

5. A method for a content provider to authorize anonymous user access to content on a computer network comprising:
receiving a request for access from a user computer having a persona identifier;
generating a challenge message including, at least in part, the persona identifier and verification data;
submitting the challenge message to a persona server;
receiving an authentication object from the persona server and forwarding the authentication object to the user computer, the authentication object including the verification data enveloped such that it is accessible only by an authorized user of the persona identifier;
receiving the verification data from the user computer; and
granting access to the user computer if the verification data is correct.

6. The method of authorizing anonymous access to content according to claim 5, wherein the verification data is pseudo-random data generated in response to the request for access.

7. The method of authorizing anonymous access to content according to claim 5, wherein the user extracts the verification data from the authentication object using data retrieved from the persona server.

8. The method of authorizing anonymous access to content according to claim 5, wherein the user is a member of a group of users.

9. The method of authorizing anonymous access to content according to claim 5, wherein the user has a plurality of persona identifiers.

10. A method of providing authentication data for a user of a persona to access content anonymously comprising:
creating an access record based at least in part on a persona identifier and associating the persona identifier with substantially unique encryption data;
receiving a challenge message from a content provider computer including the persona identifier and verification data;
enveloping at least the verification data in accordance with the encryption data in the access record associated with the persona identifier to generate an authentication object; and
providing the authentication object to at least one of the content provider and the persona user.

11. The method of providing authentication data for a user of a persona according to claim 10, wherein the authentication object is passed to the content provider and from the content provider to the persona user.

12. The method of providing authentication data for a user of a persona according to claim 10, wherein the authentication object is passed to the persona user.

13. A system for authenticating a user of an anonymous persona prior to granting access rights on a public network comprising:
a plurality of client computers operatively coupled to the public network, the client computers storing at least one persona identifier;
a persona server operatively coupled to the public network, the persona server maintaining a database of access records associated with a plurality of persona identifiers, the access records associating each persona identifier with corresponding decryption data;
at least one content provider computer operatively coupled to the public network, in response to a request for access from one of the plurality of client computers using a persona identifier, the content provider computer generating a challenge message including the persona identifier and verification data associated with the request for access, the content provider computer submitting the challenge message to the persona server, the persona server receiving the challenge message and generating an authentication object including the verification data encrypted based on the access record associated with the persona identifier, the authentication object is presented to the client computer requesting access which, if authentic, retrieves data from the access record, decrypts the authentication object and returns the verification data to the content provider computer to establish user authentication.

14. The system for authenticating a user of an anonymous persona according to claim 13, wherein the persona server comprises:
an authentication server operatively coupled to the public network;
a digital rights management server operatively coupled to the authentication server; and
an account management server operatively coupled to the authentication server, to the digital rights management server and to the public network.

15. The system for authenticating a user of an anonymous persona according to claim 13, wherein the plurality of client computers include secure hardware for storing the at least one persona identifier.

16. The system for authenticating a user of an anonymous persona according to claim 15, wherein the secure hardware is a SURF hardware device.
